(19) United States
(12) Patent Application Publication
(10) Pub. No.: US 2004/0165597 A1
(43) Pub. Date: Aug. 26, 2004

(54) Service level agreement driven route table selection

(76) Inventors: Jeremy Bicknell, Carlsbad, CA (US); Daniel Fu, Sunnyvale, CA (US); Axel K. Kloth, Mountain View, CA (US); Stephen M. Mills, Sharon, MA (US); Warner Andrews, Boulder, CO (US); Paul Bergantino, Lexington, MA (US); Moshe De-Leon, Kiron (IL)

Correspondence Address: Jack I. J'maev, Intelictual Property Development, 12616 Lewis Avenue, Chino, CA, 91710, US

(21) Appl. No.: 10/369,443

(22) Filed: Feb. 20, 2003

(51) Int. Cl. H04L 12/28

(52) U.S. Cl. 370/395.31; 370/395.21

(57) ABSTRACT

Alternate routing tables selected according to data packet priority or according to source and destination addresses of data packet. Data packet propagated to egress port according to indicator provided by selected routing table with expediency dictated by data packet priority or priority indicator stored in the selected routing table.

### FIELD OF THE INVENTION

This invention relates generally to data networking; more specifically to dynamic selection of router tables.

### BACKGROUND OF THE INVENTION

The proliferation of high-speed networking has spawned a new generation of computer applications that are “network aware”. These network aware applications have evolved in an era where network performance could not be entirely relied upon. Because of this, many network aware applications have not been developed to the full limit of their potential because of network latency, jitter and data loss.

Recognizing the significant advances that could be made in network aware applications, a new standard's group chartered with specifying a new Internet structure is promulgating definitions for network reliability and performance. These specifications are collectively referred to as “Internet 2” (I-2).

Among the types of applications that could be developed in a network environment that supports policed networking performance are real-time control applications. These may include, but are not necessarily limited to remote instrumentation and closed loop control of complex distributed systems. Closed loop control applications could also include remote manipulators that accept commands from one location and cause mechanisms to articulate. Less demanding applications could include real-time video. These could support remote medical diagnosis and treatment.

In networking terms, performance is usually defined in terms of “quality of service” (QOS). The actual definition of QOS remains vague in light of current literature, but seems to encompass metrics for network delay and jitter. For the purposes of this disclosure, network delay refers to the amount of time needed to propagate a quantum of data from one node attached to a network to a second node attached to that network. Jitter is typically used to describe the amount of variation in the period of time between quantums of data received at a second node where the quantums of data were dispatched from a first node on a regular period.

The I-2 standard attempts to control network performance by characterizing network nodes that forward quantums of data. In a packet-switched network, a quantum of data may be thought of as a “packet”. As a packet is forwarded from one node to another, it is said to “hop” across a node. According to the I-2 definitions introduced thus far, the performance of each node can be characterized in terms of its “per-hop-behavior” (PHB). Internet 2 uses the notion of PHBs to support a new type of networking service called “differentiated services”. Under the differentiated services paradigm, data packets are propagated through the network in streams. These streams are then bundled together to form aggregates. Each aggregate can then be forwarded through nodes in the network using one of several predefined per-hop-behaviors. In one working example, a stream of live video may be bundled together with other similar data streams into an aggregate. Because live video needs to be delivered with minimal latency and jitter, the aggregates carrying this type of data may be given a higher priority than other data as it traverses the network.

A PHB, then, can be considered a type of priority scheme that defines how a packet of data is handled when it arrives at a node in the network. I-2 has already defined at least two PHB classes. One PHB class is called Assured Forwarding (AF). The other PHB class is called Expedited Forwarding (EF).

The AF PHB class is true to its name. Packets are assured of being forwarded through a node. One caveat associated with the AF behavior is that not all packets will be forwarded with the same expediency. Three priority levels can be assigned to an aggregate of data streams using the AF PHB. Priority 1 aggregates are propagated in preference to priority 2 or 3 aggregates. Priority 2 is of higher importance than Priority 3. Expedited Forwarding is a PHB that preempts all AF stream aggregates. To support this PHB, a node must be able to forward a data packet immediately and with as little latency as possible. All other data must either be buffered or dropped.

In a classic switched-packet network, a packet is routed to another node based on the address carried by the packet in a packet header. This is normally called the “destination address”. Within each node, a data router or switch receives the packet. The router or switch typically comprises a routing table that stores a mapping of egress ports based on the destination address. In simple terms, the destination address is used as an index into the routing table. As a packet arrives in the router, the destination address is used to select a value from the routing table. That value defines the egress port that the individual data packet will be directed to.

The data routers or switches at each node can be referred to as forwarding devices. Typically, a forwarding device can only switch a finite number of data packets in a given amount of time. When more packets arrive at a data node than can be switched, they must be either buffered or dropped. When a data packet is buffered, it will eventually be switched according to the routing table. Switching will be effected when switching resource become available. Dropped data packets can not be salvaged and the networking infrastructure relies on higher levels of communication protocols to retransmit a lost packet.

Under the I-2 proposal, differentiated services are provided by assigning a data stream to an aggregate wherein each aggregate is routed through a path in the network having a controlled PHB at each node. Three major problems with the I-2 proposal are immediately apparent.

First, the notion of grouping data streams into aggregates requires some form of network bandwidth management. I-2 addresses this by introducing a new hardware element called a bandwidth broker. This adds additional complexity and cost to an already expensive wide area network infrastructure.

Second, individual data streams cannot contend for network resources on an end-to-end basis. Hence, virtual circuits between users can not be established because network PHBs can not be managed at the extreme ends of the connection. The PHB concept is only applicable to aggregates and it may be several hops before a data stream can be included in an appropriate aggregate.

Thirdly, a PHB can not account for disruptions or congestion in communications channels. A node may be able to forward a packet to an egress port, but that port may not have the capacity to accommodate the spirit of a high priority PHB such as EF. This results in an unavoidable delay that PHBs cannot effectively contend with.

Given the present mindset of the I-2 specifications and the entire notion of PHB definitions for controlling the QOS of a data network, there has been no means of establishing virtual connections between users on an end-to-end basis. These virtual connections must be supported with appropriate routing capability along the switching path so that any particular QOS commitment may be respected. Hence, routing strategies must be capable of honoring QOS commitments in the face of congested or unavailable data paths.

### SUMMARY OF THE INVENTION

In order to truly enable the potential of network aware applications, a new generation of wide area networks (WAN) must allow individual applications to manage their own QOS needs. Any such WAN should probably be compatible with the PHB notion specified by the I-2 specifications now being disseminated because that standard may become a popular means of achieving controlled QOS networking structures. This means that any new QOS capabilities beyond those specified by I-2 must be capable of being integrated into the new Internet with ease.

The present invention expands on the notions introduced by the I-2 specifications and comprises a method for forwarding quantums of data. The present invention also comprises an apparatus that embodies this method. In one illustrative embodiment, the apparatus comprises a data router or data switch that may be disposed as a forwarding element in a node. Such a device is referred to as a “forwarding device”.

According to one illustrative method of the present invention, a quantum of data may be received and a routing table may then be selected according to a QOS indicator contained in the quantum of data. In furtherance of this illustrative method, an egress port may be selected by using a destination address that also contained in the quantum of data. This selection may occur by using the destination address as an index into the selected routing table. The quantum of data may then be propagated to the selected egress port.

In one variation of this illustrative method, the step of using the QOS indicator as a means of selecting a routing table may comprise extraction of a priority indicator from the quantum of data and then using that priority value to select a routing table. The method of the present invention may use I-2 type PHBs as a priority indicator.

In yet another variation of this illustrative method, selection of the routing table may be accomplished by extracting a source and destination address from the quantum of data. These addresses may be used to index a table. This table may comprise selector values that correspond to various QOS levels that may need to be honored between the source and destination address. These levels may need to be honored as a result of contractual service level agreements (SLAs). The selector value may then be used to select a particular routing table. This provides the capability of establishing end-to-end QOS enforcement. In yet a third variation of this illustrative method, the selector table that provides the selector value for selecting a routing table may be indexed by the source address, the destination address and a priority that may all be extracted from the quantum of data.

Once a routing table has been selected, the process of directing a quantum of data to a selected egress port may be accomplished by receiving the quantum of data in a switching element. In some methods of the present invention, the switching element may have an ingress port and a plurality of egress ports. According to one variation of the illustrative method, the selected routing table may provide an egress indicator to the switching element. The switching element may then direct the quantum of data to the egress port corresponding to the egress indicator. In yet another variation of this illustrative method, the switching element may propagate the quantum of data with expediency dictated by a priority indicator that the switching element may receive. The priority indicator may comprise a value extracted from the quantum of data itself or it may be provided by the selected routing table.

The present invention also comprises a data router or a data switch that embodies the method of the present invention. These types of apparatus are referred to as forwarding devices. According to one example embodiment, a forwarding device may comprise a receiver, an extractor, a switching element, a plurality of routing tables and a QOS table selector. Typically, the receiver receives a quantum of data and the extractor extracts a destination address from the quantum of data.

Once the extractor has extracted the destination address from the quantum of data, the destination address may be used as an index to retrieve an egress indicator from a particular routing table. The QOS table selector typically generates a selector signal that enables one particular table from the plurality. The switching element may then receive the quantum of data and the egress indicator and may direct the quantum of data to an egress port corresponding to the egress indicator.

According to one example embodiment of the present invention, the QOS table selector comprises a QOS extractor that extracts a QOS indicator from the quantum of data. This QOS indicator, which may be a priority level, may then be used as the selector signal that enables a particular table from the plurality of routing tables comprising the invention. In another example embodiment, the QOS table selector may comprise a QOS extractor that extracts a source address from the quantum of data and a selector table that stores selector values. These selector values may correspond to different routing tables that may be selected when the selector table is indexed by the extracted source address and the destination address. In one additional embodiment of the present invention, the QOS extractor may extract a QOS indicator and a source address and the selector table may be indexed by QOS indicator, the source address and the destination address.

In one illustrative embodiment of the present data switch, the switching element may comprise an ingress port and a plurality of egress ports. As a forwarding device of the present invention operates, a quantum of data may be directed to the ingress port of the switch element. The egress indicator from the routing table may be directed to the switch element. The switch element typically directs the quantum of data to the egress port corresponding to the egress indicator. In some embodiments of this invention, the switching element propagates a quantum of data with expediency dictated by a priority indicator. The priority indicator may be provided to the switching element either from the routing table or it may be based on a priority comprising the data quantum that is extracted by a priority extractor further comprising the invention.

The present method may also be embodied in a QOS table manager. The QOS table manager that comprises the invention may be used as a building block to construct a forwarding device that comprises the invention. Accordingly, the QOS table manager may comprise a parsing engine and a routing table array. The parsing engine typically captures a destination address, as it perceives a quantum of data. The parsing engine may also capture QOS indicator from the quantum of data. This QOS indicator may be a priority indicator, for example an I-2 PHB. These may then be used to select a particular egress indicator stored in the plurality of tables. Typically, the priority is used to select a table from the routing table array and the destination address is used as an index to select an egress indicator from the selected table. The QOS table manager may then provide an egress indicator that may be used by a switching element or other means of propagating a quantum of data. The QOS table manager may also provide a priority that may further be stored in the selected routing table.

In one alternative embodiment of a QOS table manager, the QOS table manager comprises a parsing engine that captures a destination address and a source address from a quantum of data that it may perceive on its input. The source address may be used in conjunction with the destination address to select one of a plurality of routing tables comprising the QOS table manager. The QOS table manager may then provide an egress indicator when the selected routing table accesses using the destination address as an index. This alternative QOS table manager may also provide a priority indicator in addition to the egress indicator.

### BRIEF DESCRIPTION OF THE DRAWINGS

The foregoing aspects are better understood from the following detailed description of one embodiment of the invention with reference to the drawings, in which:

FIG. 1 is a network topology diagram useful in illustrating the concepts of the present invention;

FIG. 2 is a flow diagram that depicts one illustrative method for forwarding data packets according to the present invention;

FIG. 3 is a flow diagram that depicts an example method according to the present invention for establishing QOS based virtual circuits on an end-to-end basis;

FIG. 4 is a flow diagram that depicts one illustrative method for switching data packets according to the present invention;

FIG. 5 is a block diagram of one example embodiment of a forwarding device constructed in accordance with the teachings of the present invention; and

FIG. 6 is a block diagram of one illustrative component part that may be used to construct a data switch or router according to the teachings of the present invention.

### DETAILED DESCRIPTION OF THE INVENTION

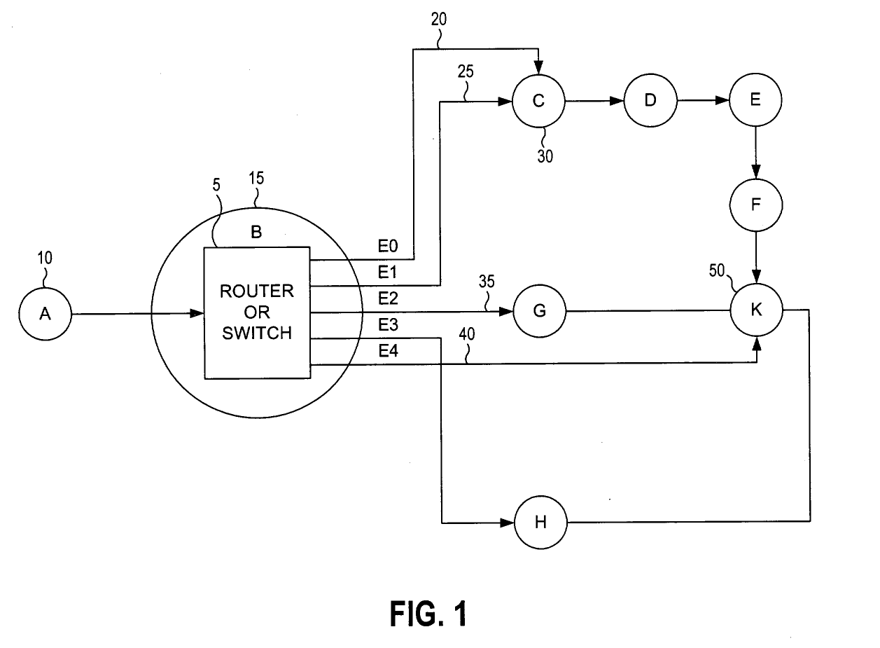

FIG. 1 is a network topology diagram useful in illustrating the concepts of the present invention. In many networks, a first node 10 may deliver a quantum of data to a second node 15. The quantum of data may be a data packet used in a packet switching network. For the purposes of this disclosure, the use of a data packet will be discussed, but the invention is not intended to be limited to the propagation of data packets. Any quantum of data may be used.

As a packet of data arrives at the second node 15, it may comprise a destination address that requires that the packet be forwarded to a final node 50. The second node 15 typically comprises a data router or a data switch 5.

These may be referred to as forwarding devices. A forwarding device 5 may comprise a routing table that is used to determine which egress port should be used when a data packet is forwarded. Such routing tables have traditionally been updated on a periodic basis to reflect changing network conditions.

In one example system, the routing table in the forwarding device 5 may be changed to forward a packet that must be delivered to the final node 50 by way of a path consisting of nodes C to D to E to F and finally to K. This path may be selected because other paths are either unavailable or have become congested. In this conceptual description, the direct path 40 from the second node 15 to the final node 50 may have failed. In this case, the routing table may be changed to route data packets through the aforementioned route through node C (30).

Considering another example, the routing table may again direct packets bound for the final node K (50) through node C (30) because the communications channels through either nodes G or H are needed for data traffic bound for either of those nodes directly. Management of the routing table is typically conducted by network management functions that monitor the usage and availability of various network elements and arrive at apparently efficient routing maps for each router that forwards data through the network infrastructure.

This is where the concept of PHB policing, as defined by the I-2 specifications, breaks down. When an aggregate of data streams arrives at the second node 15, the forwarding device 5 can only perform in accordance with a PHB. Even if a packet is to be expedited, routing the aggregate to the egress port specified in the routing table may impair data flow. This can happen where the routing table specifies an inefficient data path to the final destination.

As the network operates, the most efficient path to node K may be used for the bulk of the data flowing through the network. Perhaps this data is AF3, the lowest of all PHBs specified in support of I-2 differentiated services. This data may be flowing to nodes G and H. In an operational scenario where the direct path 40 is unavailable, network management may map the inefficient path of C to D to E to F as the path to node K. When an EF aggregate arrives at the second node 15, it will be forced by virtue of the operational history of the network to be forwarded through the inefficient path dictated by the routing table comprising the forwarding device 5.

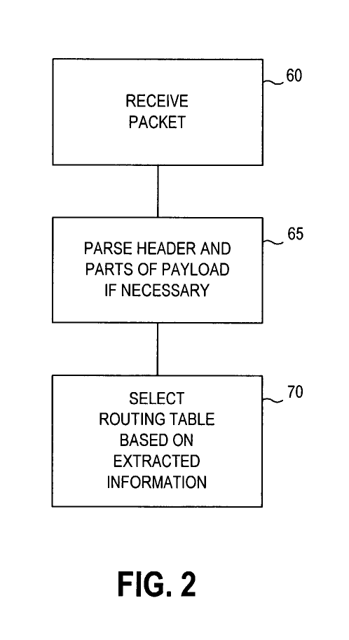

FIG. 2 is a flow diagram that depicts one illustrative method for forwarding data packets according to the present invention. The method of the present invention addresses the problem of routing data packets into inefficient network paths by first receiving a data packet at a node (step 60) and then extracting a quality of service information from the data packet (step 65). The quality of service information may be a PHB according to the I-2 specifications. The method of the present invention provides that the quality of service information for a data packet may be used to select an alternate routing table (step 70). In some cases, the quality of service information may be in a packet header, as may be the case where source and destination addresses comprise a part of the QOS information. In other cases, the payload itself must be parsed in order to extract other QOS information, for example a PHB. These are but some examples of QOS information that are meant to illustrate, but not limit the scope of the present invention.

In the example operating scenario described above where a routing table dictates an inefficient path to a final node K (50), an aggregate of data streams tagged with the EF PHB would use an alternative routing table. That alternative routing table may then direct the aggregate to node K (50) using a path having fewer hops.

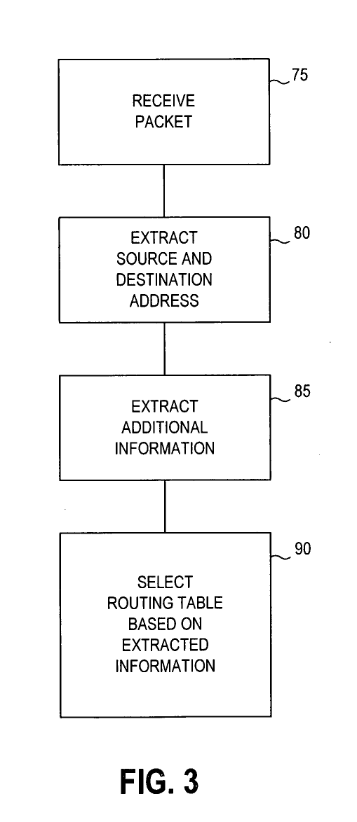

FIG. 3 is a flow diagram that depicts an example method according to the present invention for establishing QOS based virtual circuits on an end-to-end basis. Where I-2 requires a data stream to be incorporated into an aggregate before PHB concepts can be applied, the method of the present invention acknowledges that QOS requirements may exist between two ends of a communications channel. Accordingly, after a data packet is received (step 75) the source address of the data packet is extracted (step 80). The destination address may also be extracted. Additional QOS information may additionally be extracted from the data packet (step 85).

Once the source and destination addresses have been extracted along with any other QOS information from the data packet, these may be used to select an alternate routing table (step 90). It should be noted that some alternative methods of the present invention may actually use the source address, the destination address and other QOS information to collectively select an alternative routing table. In some variations of the present method, the priority (which may be an I-2 PHB) of the data packet may be extracted and used as primary or additional QOS information. By selecting an alternative routing table based on the source address, the destination address and other QOS information, the method of the present invention allows QOS cognizant networking to be established between individually addressable devices attached to the network.

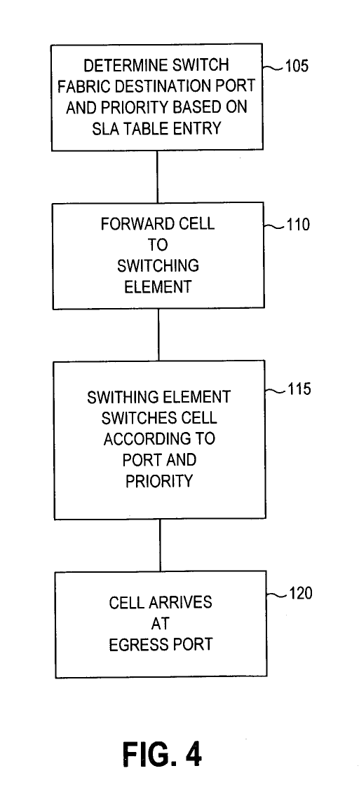

FIG. 4 is a flow diagram that depicts one illustrative method for switching data packets according to the present invention. Once an alternative routing table has been selected according to the teachings of the present invention, a data packet may be directed to a switching element (step 105). The switching element may require that a priority for switching a packet should be received substantially with the data packet (step 110). In some embodiments of the present method, the switching element may receive a priority indicator directly from the data packet. In one alternative method of the present invention, the routing table may provide a substitute priority indicator.

The switching element that forwards the data packet typically receives an egress port indicator. This egress port indicator, which may be provided by the selected routing table, is used by the switching element either alone or in conjunction with the priority indicator to select an egress port to which the data packet is to be directed (step 115). The switching element may then direct the data packet to that selected egress port (step 120).

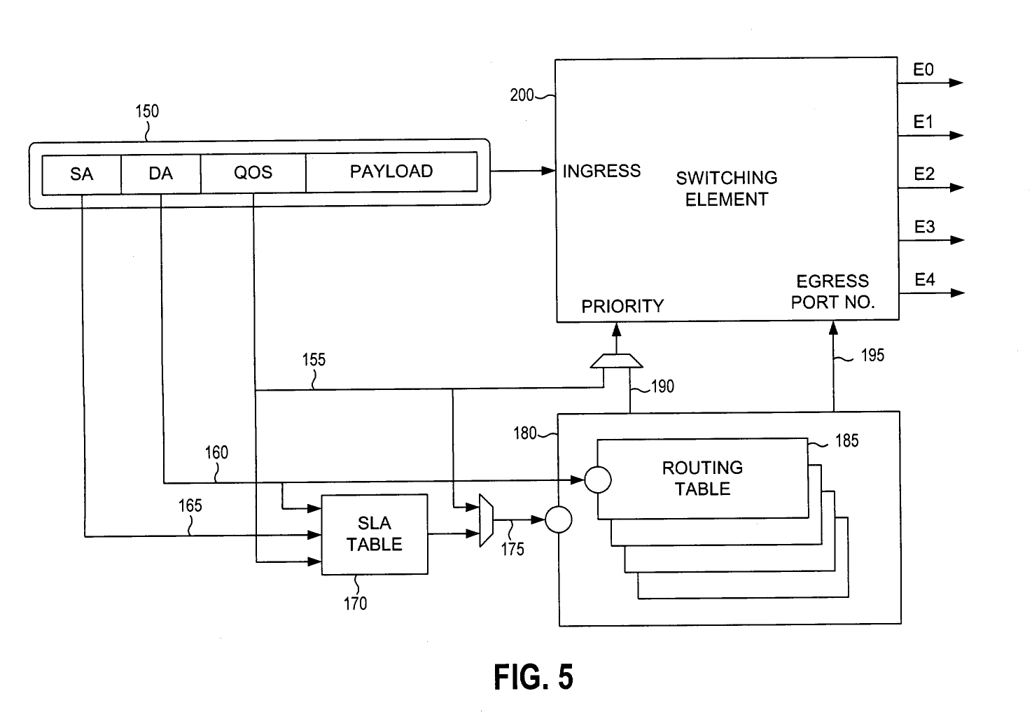

FIG. 5 is a block diagram of one example embodiment of a forwarding device constructed in accordance with the teachings of the present invention. According to this example embodiment, a forwarding device may comprise a switching element 200 and a plurality of routing tables 180. The forwarding device may also optionally comprise a service level agreement (SLA) table 170. According to this illustrative embodiment, QOS information from an arriving data packet 155 may be used as a selector 175 to select one of the plurality of routing tables 185. The destination address 160 of the data packet 150 may then be used as an index into the selected routing table 185. According to one alternative embodiment of the present invention, QOS information may be in the form of a PHB as defined by the I-2 specifications.

According to one alternative embodiment of a forwarding device according to the present invention, the source address 165 and the destination address 160 from a data packet 150 may be used to create a selector 175 to select one of the plurality of routing tables 185 comprising the invention. In one embodiment, the source address 165 and the destination address 160 are used to directly address the SLA table 170 that may map the source and destination address pair into a QOS selector 175. Once a routing table 185 has been selected by the selector 175, the destination address 160 may then be used to select an entry in the routing table.

Routing table entries typically comprise an egress indicator 195 that may be used by the switching element 200 to direct a data packet 150 to a particular egress port. The switching element 200 may also use other QOS indicators from the data packet. In one example embodiment, a priority indicator may be extracted from the data packet and used as a priority indicator 155 to determine the expediency to apply in propagating a particular data packet 150 to an egress port. The switching element 200 may also use an alternative priority indicator 190 from the routing table 185. In these example embodiments of the invention, the routing tables may be loaded by a network management function that provides for alternative routing of data packets commensurate with the QOS each individual packet is to be afforded. Also, these example embodiments may further comprise suitable data extractors for extracting any one or all of the source address, the destination address and other QOS information from a quantum of data (for instance a data packet). In one alternative embodiment, a PHB may be extracted from a data packet as one form of additional QOS information.

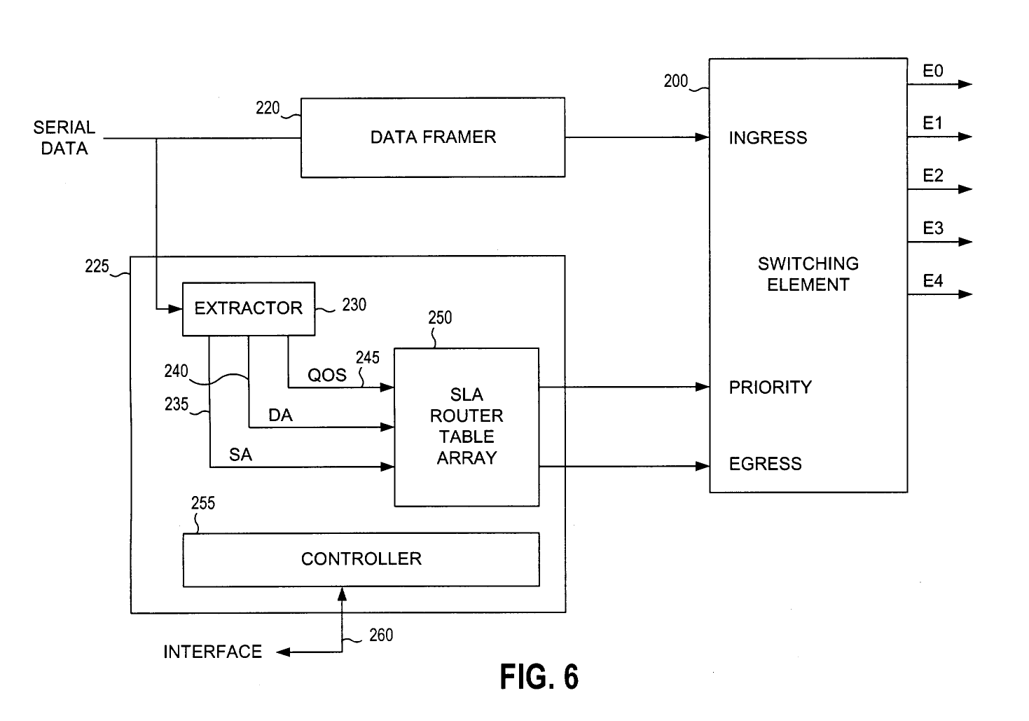

FIG. 6 is a block diagram of one illustrative component part that may be used to construct a data switch or router according to the teachings of the present invention. The present invention may also comprise a SLA table manger embodied as a component part. Such a component part 225 may be used in conjunction with a switching element 200 and a data framer 220 to construct a data switch or router. According to this alternative embodiment of the present invention, the SLA table manager 225 may comprise a parsing engine 230 that captures a quantum of data as it is arrives at an input port of a forwarding device. Data arriving at the input of a forwarding device may be concurrently framed by a data framer 220 and presented to a switching element 220. In one embodiment, the parsing engine 230 may extract a quantum of data from a serial data stream in a manner analogous to the functionality of the data framer 220. The parsing engine 230 may extract other QOS information from a quantum of data. In one example embodiment, the parsing engine may extract a priority indicator 245 from the data stream. The parsing engine 230 may also extract a source 235 and a destination 240 address from a quantum of data.

The SLA table manager may further comprise a routing table array 250. The routing table array 250 may accept several indices. The routing table array 250 may accept a priority 245 from the parsing engine 230. This priority 245 may be used to select a routing table from the routing table array 250. The selected routing table may then be indexed with a destination address 240 that may also be obtained from the parsing engine 230. In one alternative embodiment of a SLA table manager 225, a specific routing table from the routing table array 250 may be selected according to the source address 235 and the destination address 240 extracted from the data packet captured by the parsing engine230. In yet another alternative embodiment, selection of a specific routing table may be accomplished according to the priority 245, the source address 235 and the destination address 240 collectively.

The routing table array may be loaded with egress indicators that may be used to direct the switching element 200 to route a particular quantum of data to a particular egress port. The routing table array may also be loaded with a priority indicator that may be used to cause the switching element 200 to propagate a particular quantum of data with a particular level of expediency. The SLA table manager 225 may further comprise an interface 260 that may be used to communicate with a controller 255 that may further comprise the SLA table manager 225. The controller 255 may be used to load egress or priority indicators into the routing table array 250 and to control the functions of the parsing engine230.

The SLA table manager may also comprise a controller 255. The controller may be used to control the functions of the SLA table manager 225 according to dictates that may be received by way of a controller interface 260 that may further comprise the invention.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for propagating a quantum of data through a network node comprising the steps of:
receiving a quantum of data;
selecting a routing table based on a QOS indicator for the quantum of data;
selecting a egress port to which to route the quantum of data according to a value retrieved from the selected routing table and wherein said value is retrieved by indexing said table according to a destination address contained in said quantum of data; and
propagating the quantum of data to the selected egress port.

2. The method of claim 1 wherein the step of selecting a routing table based on a QOS indicator for the quantum of data comprises the steps of:
extracting a priority indicator from the quantum of data; and
selecting a routing table according to the extracted priority indicator.

3. The method of claim 1 wherein the step of selecting a routing table based on a QOS indicator for the quantum of data comprises the steps of:
extracting a source address from the quantum of data;
extracting a destination address from the quantum of data;
retrieving a selector from a table by indexing the table with said source and destination addresses; and
selecting a routing table according to the retrieved selector.

4. The method of claim 1 wherein the step of selecting a routing table based on a QOS indicator for the quantum of data comprises the steps of:
extracting a source address from the quantum of data;
extracting a destination address from the quantum of data;
extracting quality of service information from the quantum of data;
retrieving a selector from a table by indexing the table with said source and destination addresses and quality of service information; and
selecting a routing table according to the retrieved selector.

5. The method of claim 1 wherein the step of propagating the quantum of data to the selected egress port comprises:
receiving the quantum of data in a switching element that comprises an ingress port and a plurality of egress ports;
receiving an egress indicator from the selected routing table; and
directing the quantum of data to the egress port according to the egress indicator.

6. The method of claim 1 wherein the step of propagating the quantum of data to the selected egress port comprises:
receiving the quantum of data in a switching element that comprises an ingress port and a plurality of egress ports;
receiving in the switching element the retrieved value from the selected routing table;
receiving in the switching element a priority indicator from the quantum of data; and
directing the quantum of data to the egress port according to the retrieved value with an expediency dictated by the priority indicator.

7. The method of claim 1 wherein the step of propagating the quantum of data to the selected egress port comprises:
receiving the quantum of data in a switching element that comprises an ingress port and a plurality of egress ports;
receiving in the switching element the retrieved value from the selected routing table;
receiving in the switching element a priority indicator from the selected routing table; and
directing the quantum of data to an egress port according to retrieved value with an expediency dictated by the priority indicator.

8. A forwarding device comprising:
receiver that receives a quantum of data;
extractor that extracts a destination address from the quantum of data;
plurality of individually selectable routing tables that store a plurality of egress port indicators and provide a particular egress port indicator when one table is selected and indexed by said destination address;
quality of service (QOS) table selector that generators a selector signal that selects one of the routing tables from the plurality of individually selectable routing tables; and
switching element that propagates the quantum of data to a particular egress port according to an egress port indicator received from the selected routing table.

9. The forwarding device of claim 8 wherein the QOS table selector comprises:
QOS extractor that extracts quality of service information from the quantum of data and wherein the quality of service information is used as a selector signal.

10. The forwarding device of claim 8 wherein the QOS table selector comprises:
QOS extractor that extracts a source address from the quantum of data;
selector table that stores a plurality of values and wherein the selector table provides a particular value that is used as a selector signal when the selector table is indexed by the extracted destination address and the extracted source address.

11. The forwarding device of claim 8 wherein the QOS table selector comprises:
QOS extractor that extracts a source address and quality of service indicator from the quantum of data;
selector table that stores a plurality of values and wherein the selector table provides a particular value that is used as a selector signal when the selector table is indexed by the extracted destination address and the extracted source address and the extracted quality of service indicator.

12. The forwarding device of claim 8 wherein the switching element comprises:
switching element that comprises an ingress port and a plurality of egress ports that receives the quantum of data at its ingress port and directs the quantum of data to an egress port according to an egress indicator that it receives from the selected routing table.

13. The forwarding device of claim 8 further comprising:
priority extractor that extracts a priority from the quantum of data and wherein the switching element comprises:
ingress port; and
plurality of egress ports and wherein the switching element receives the quantum of data at its ingress port and directs the quantum of data to an egress port according to an egress indicator that it receives from the selected routing table with an expediency dictated by said extracted priority.

14. The forwarding device of claim 8
wherein the selected routing table further provides a priority indicator when one table is selected and indexed by said destination address and
wherein the switching element comprises:
ingress port; and
plurality of egress ports and wherein the switching element receives the quantum of data at its ingress port and directs the quantum of data to an egress port according to an egress indicator that it receives from the selected routing table with an expediency dictated by said priority indicator.

15. A QOS table manager comprising:
parsing engine comprising an input that captures a destination address and a quality of service indicator from a quantum of data perceived at its input;
routing table array comprising a plurality of routing tables capable of storing a plurality of egress indicators and wherein one of said tables is selected according to the quality of service indicator captured from the quantum of data and wherein the selected table provides a particular egress indicator when it is indexed by the captured destination address.

16. The QOS table manager of claim 15 wherein the plurality of router tables further are capable of storing a plurality of priority indicators and wherein the selected table further provides a particular priority indicator when it is indexed by the captured destination address.

17. A QOS table manager comprising:
parsing engine comprising an input that captures a destination address and a source address from a quantum of data perceived at its input;
routing table array comprising a plurality of routing tables that are capable of storing a plurality of egress indicators and wherein one of said tables is selected according to the destination and source addresses captured from the quantum of data and wherein the selected table provides a particular egress indicator when it is indexed by the captured destination address.

18. The QOS table manager of claim 17 wherein the plurality of routing tables are further capable of storing a plurality of priority indicators and wherein the selected table further provides a particular priority indicator when it is indexed by the captured destination address.
